(19) United States
(12) Patent Application Publication
(10) Pub. No.: US 2007/0119287 A1
(43) Pub. Date: May 31, 2007

(54) Heated air horn

(75) Inventors: Loi H. Truong, Langley (CA); Dino Fantillo, Burnaby (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Airchime Manufacturing Co. Ltd., Langley (CA)

(21) Appl. No.: 11/287,242

(22) Filed: Nov. 28, 2005

(51) Int. Cl. G10D 7/10

(52) U.S. Cl. 84/387 R

(57) ABSTRACT

A heated air horn is provided in which heat is applied to the base of the bell by a cylindrical heating element incorporated into the base of the bell in a manner which does not harm the acoustics of the horn.

### TECHNICAL FIELD

The invention relates to the field of pneumatic or air horns, an in particular pneumatic or air horns which are heated for winter use.

### BACKGROUND

Air horns are widely used on locomotives, to duplicate the sound of traditional steam locomotive whistles, as well as on commercial marine vessels, trucks, for industrial uses and wide area warning. Such horns are generally exposed to the elements, and a build-up of snow or ice in winter conditions is detrimental to the performance of the horn. Consequently modifications have been made to provide electrical heating coils on the horn to melt snow or ice. For example, Pearson U.S. Pat. No. 2,409,954 discloses an air horn in which a heating grid extends across the mouth of the horn, or a heating coil extends around the inner periphery of the mouth of the horn. Eveanowsky, Jr. et al. U.S. Pat. No. 5,022,341 discloses an air horn in which three heating cartridges are provided, extending into channels in the diaphragm housing. It remains that such designs can be less effective for preventing ice buildup at the base of the horn trumpet, and effect the audible performance of the horn.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The present invention provides a heated air horn in which heat is applied to the base of the trumpet in a manner which does not harm the acoustics of the horn. More particularly the invention provides a heated air horn comprising a bell having an open end and a base end secured to a housing containing a sound-generating diaphragm, the bell having an inner surface surrounding a resonating chamber, further comprising a heating assembly mounted in the base end of the bell between the bell and the resonating chamber, the heating assembly comprising a retaining sleeve and a heating element. According to one aspect of the invention the heater assembly fits in a recess in said inner surface of the bell so that the heating element is held between the retaining sleeve and the bell, in direct contact with the bell.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a perspective view of an air horn incorporating the invention;

FIG. 2 is a lengthwise cross-section view of the air horn in FIG. 1;

FIG. 3 is a detail exploded cross-section of the air horn shown in FIG. 1;

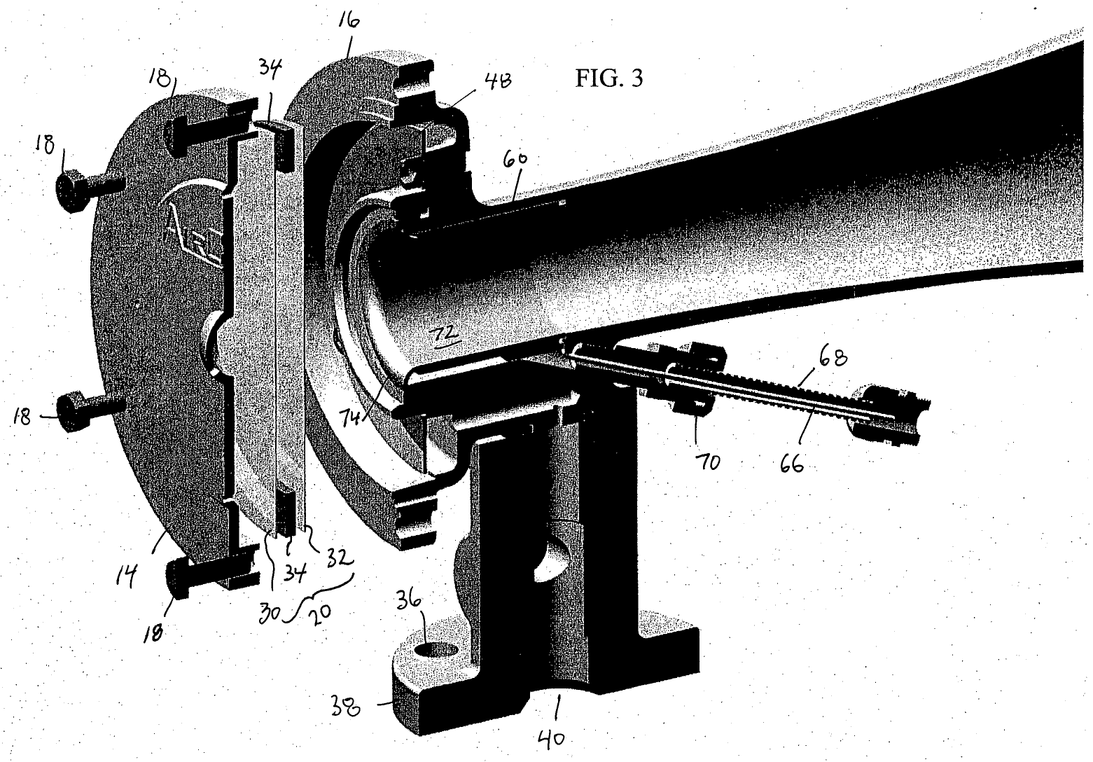

FIG. 4 is a longitudinal cross-section of the air horn shown in FIG. 1; and

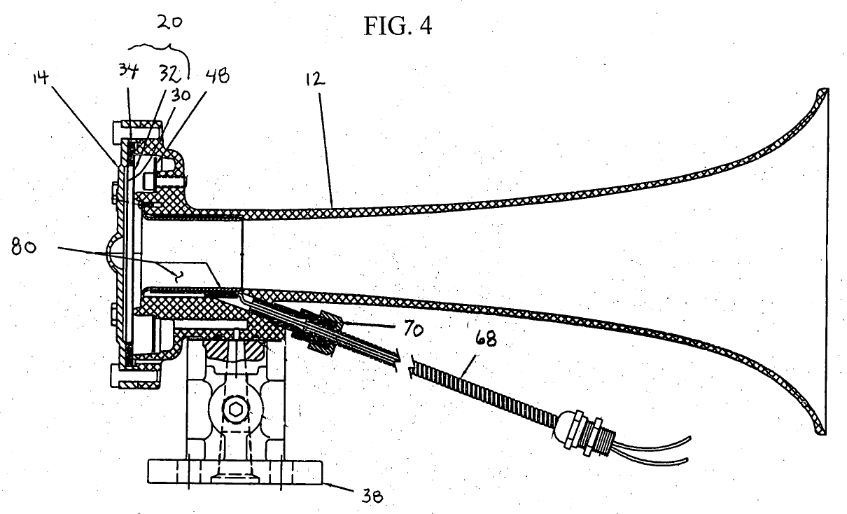

FIG. 5 is an exploded view of the air horn shown in FIG. 1.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

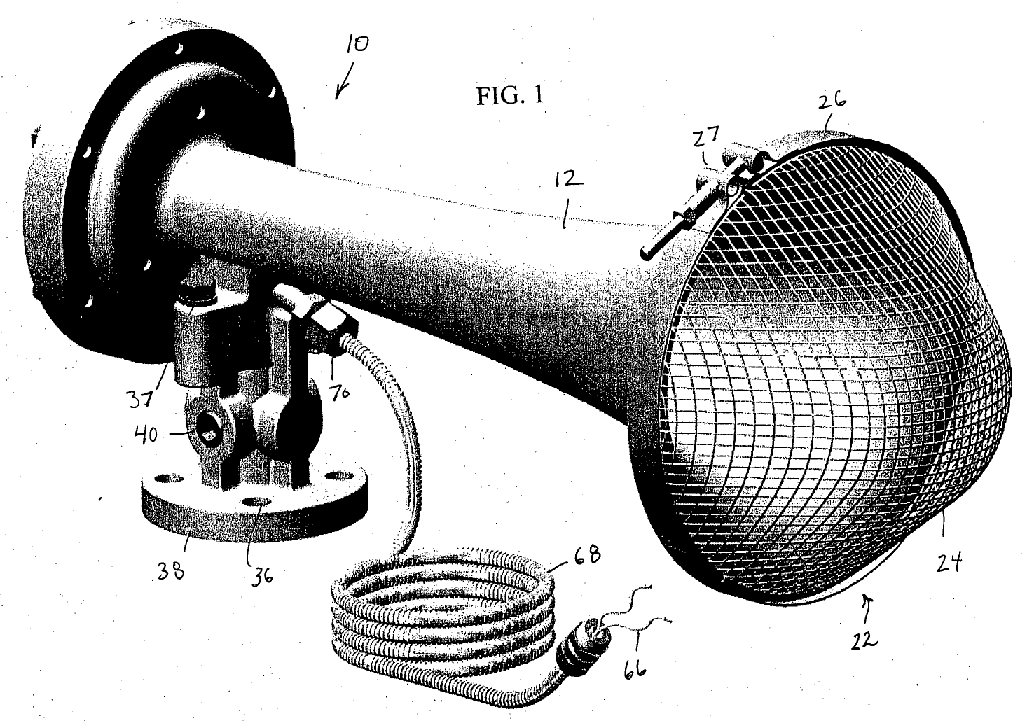

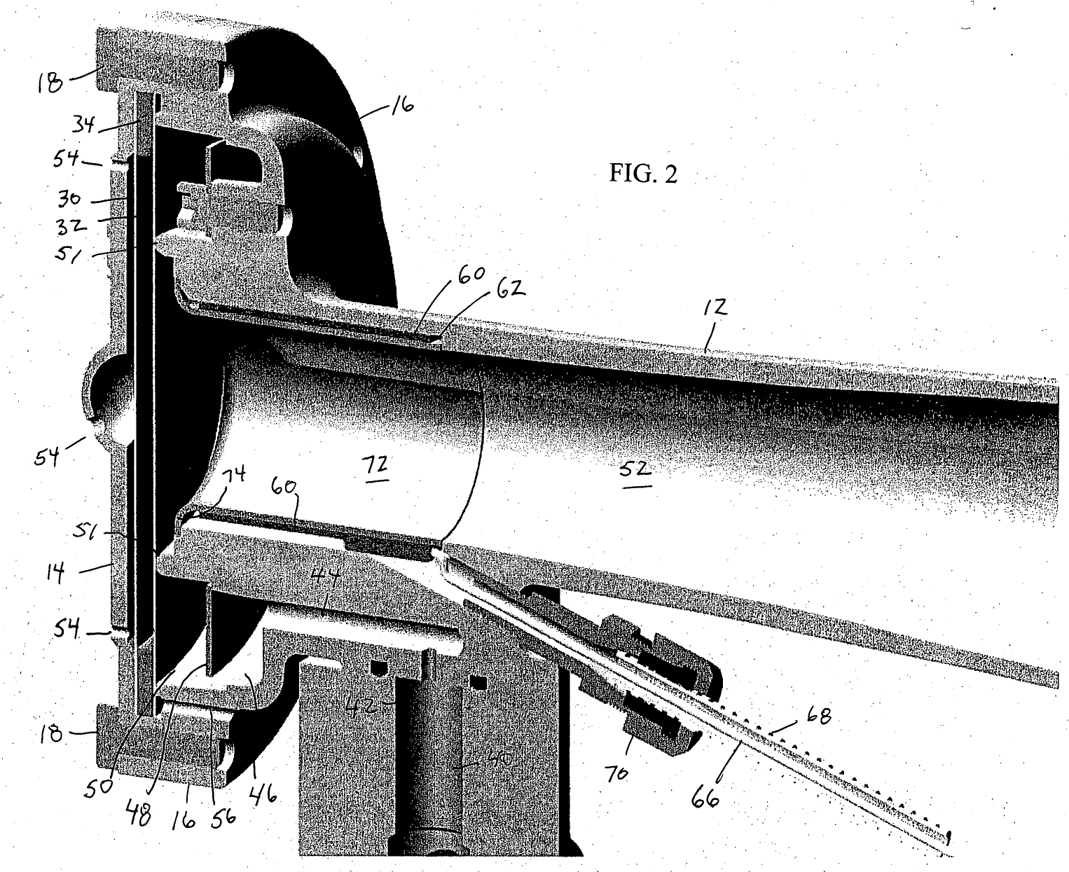

With reference to FIG. 1, air horn 10 has a flared metal trumpet horn or bell 12 made of a suitable metal such as cast aluminum and having a flared open end 22 covered by protective screen 24 held in place by adjustable ring 26 having clamp assembly 27. With reference to FIG. 2, diaphragm cap 14 is secured to diaphragm head 16 of bell 12 by bolts 18. Circular, flexible flat metal diaphragm assembly 20 is held between diaphragm cap 14 and diaphragm head 16 and is formed of two parallel circular stainless steel discs 30, 32 between which is sandwiched an annular cushion ring 34 made of silicone rubber.

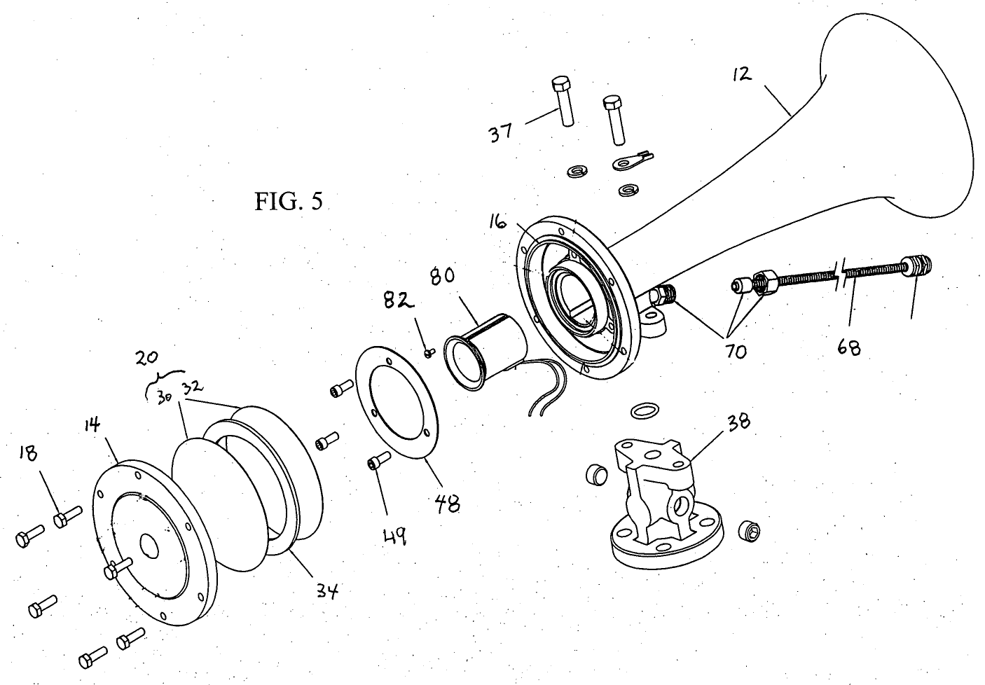

Air horn 10 is mounted on base 38 by fasteners 37 and base 38 is in turn mounted on a vehicle by fasteners extending through holes 36 in base 38. Compressed air is introduced through passage 40 in base 38 or the like. The compressed air flows through restricted aperture 42, into passage 44 and into annular chamber 46. The air flows around annular diffuser 48, which is secured to diaphragm head 16 by bolts 49 (FIG. 5), and into chamber 50, causing diaphragm assembly 20 to move off seat 51 and allowing air to escape out central chamber 52 of bell 12. Once pressure is reduced in chamber 50, diaphragm assembly 20 returns to its original position and the cycle repeats causing in the usual way a vibration of diaphragm assembly 20 and a sound wave in chamber 52 at a frequency which depends on the length of the bell 12. Holes 54 in diaphragm cap 14 relieve air pressure behind diaphragm assembly 20. Servicing access hole 56 permits access to the device for service.

Heater assembly 80 fits in cylindrical recess 62 in the base of bell 12. Heater assembly 80 comprises a heat-conducting cylindrical stainless steel retaining sleeve 72 which has a flared end 74 and a cylindrical heating element 60. Heating element 60 is constructed of a resistance conductor made from an alloy such as nichrome embedded in a fiberglass and vulcanized silicone rubber sleeve. Conductor 66 provides electric current to heating element 60 through protective cable 68 and threaded connector 70. Heating element 60 is retained in contact with bell 12 by the cylindrical retaining sleeve 72 and flared end 74. Retaining sleeve 72 and flared end 74 fit integrally in recess 62 with a friction fit and are further tightly held in place and prevented from backing out of the bell 12 by screw 82. In this way the heating element 60 is brought into direct contact with the bell 12 without altering the acoustic features of the bell.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A heated air horn comprising a bell having an open end and a base end secured to a housing containing a sound-generating diaphragm, said bell having an inner surface surrounding a resonating chamber, further comprising a heating assembly mounted in said base end of said bell between said bell and said resonating chamber, said heating assembly comprising a retaining sleeve and a heating element.

2. The heated air horn of claim 1 wherein said heater assembly fits in a recess in said inner surface of the bell.

3. The heated air horn of claim 2 wherein said heating element is held between said retaining sleeve and said bell.

4. The heated air horn of claim 3 wherein said heating element is in direct contact with said bell.

5. The heated air horn of claim 2 wherein said retaining sleeve fits integrally in said recess.

6. The heated air horn of claim 5 wherein said retaining sleeve is cylindrical and fits integrally into a cylindrical recess in said inner surface of said bell.

7. The heated air horn of claim 6 wherein said retaining sleeve is held in place and prevented from backing out of said bell by a screw fastener.

8. The heated air horn of claim 7 wherein said heating element comprises a resistance conductor and flexible sleeve.

9. The heated air horn of claim 1 further comprising an electrical conductor to provide electric current to said heating element.

10. The heated air horn of claim 8 wherein said heating element is retained in direct contact with said bell by said retaining sleeve.

11. The heated air horn of claim 6 wherein said retaining sleeve comprises a flared end which conforms to the base end of said bell.

12. A heater assembly for a heated air horn, said air horn comprising a bell having an open end and a base end secured to a housing containing a sound-generating diaphragm, said bell having an inner surface surrounding a resonating chamber, said heating assembly being adapted to be mounted in said base end of said bell between said bell and said resonating chamber, said heating assembly comprising a retaining sleeve and a heating element.

13. The heater assembly of claim 12 wherein said heater assembly is adapted to fit in a recess in said inner surface of the bell.

14. The heater assembly of claim 13 wherein said heating element is held between said retaining sleeve and said bell.

15. The heater assembly of claim 14 wherein said retaining sleeve is sized to fit integrally in said recess.

16. The heater assembly of claim 12 wherein said retaining sleeve is cylindrical and is sized to fit integrally into a cylindrical recess in said inner surface of said bell.

17. The heater assembly of claim 12 further comprising screw fastener means for securing said retaining sleeve and preventing said retaining sleeve from backing out of said bell.

18. The heater assembly of claim 12 wherein said heating element comprises a resistance conductor and flexible sleeve.

19. The heater assembly of claim 12 further comprising an electrical conductor to provide electric current to said heating element.

20. The heater assembly of claim 15 wherein said retaining sleeve comprises a flared end which conforms to the base end of said bell.
